(19) United States
(12) Patent Application Publication
(10) Pub. No.: US 2002/0062718 A1
(43) Pub. Date: May 30, 2002

(54) Wrench having a universal-joint ratchet wheel

(76) Inventor: Mei-Chen Wang, Taichung (TW)

Correspondence Address: Alan Kamrath, Rider, Bennett, Egan & Arundel, LLP, 333 South Seventh Street, Suite 2000, Minneapolis, MN, 55402, US

(21) Appl. No.: 09/727,397

(22) Filed: Nov. 29, 2000

(51) Int. Cl. B25B 13/46

(52) U.S. Cl. 81/60

(57) ABSTRACT

A wrench comprises a box end having a compartment and a cavity, a ratchet wheel rotatably mounted in the compartment, and a pawl mounted in the cavity for engaging with the ratchet wheel. The ratchet wheel is in universal joint with an inner periphery defining the compartment of the box end. Retaining edges are formed on an outer periphery of the ratchet wheel for engaging with the pawl to thereby prevent disengagement of the ratchet wheel from the compartment of the box end.

### BACKGROUND OF THE INVENTION

1. Field of the Invention

The present invention relates to a wrench having a universal-joint ratchet wheel, and more particularly to a wrench having a box end in which a universal-joint ratchet wheel is mounted.

2. Description of the Related Art

Wrenches have been widely used and most of them are limited in function especially when the fasteners to be loosened or tightened are located in a difficult-to-access area. The present invention is intended to provide an improved design to solve this problem.

### SUMMARY OF THE INVENTION

It is the primary object of the present invention to provide an improved wrench having a box end in which a universal-joint ratchet wheel is mounted. The universal-joint ratchet wheel allows the user to loosen/tighten fasteners that cannot be engaged with the wrench in an upright manner.

A wrench in accordance with the present invention comprises:

a box end comprising a compartment and a cavity;

a ratchet wheel rotatably mounted in the compartment, the ratchet wheel being in universal joint with an inner periphery defining the compartment of the box end, the ratchet wheel including a plurality of teeth on an outer periphery thereof;

a pawl mounted in the cavity for engaging with the ratchet wheel;

means for biasing the pawl toward the ratchet wheel and thus engaging with the teeth of the ratchet wheel.

The wrench further comprises means for restraining a tilt angle of a central axis of the ratchet wheel relative to a central axis of the compartment of the box end. The ratchet wheel includes an inner polygonal periphery for engaging with a fastener. The wrench may further comprise means for changing position of the pawl relative to the ratchet wheel, thereby changing ratcheting direction of the wrench. The outer periphery of the ratchet wheel includes an annular groove for receiving a C-clip to thereby rotatably mount the ratchet wheel in the compartment of the box end. The outer periphery of the ratchet wheel includes an annular ledge formed on an end thereof for engaging with the pawl to prevent disengagement of the ratchet wheel from the compartment of the box end. Alternatively, the outer periphery of the ratchet wheel includes a first annular ledge and a second annular ledge that is axially spaced from the first annular ledge, each of the first annular ledge and the second annular ledge being engagable with the pawl to prevent disengagement of the ratchet wheel from the compartment of the box end.

Other objects, advantages, and novel features of the invention will become more apparent from the following detailed description when taken in conjunction with the accompanying drawings.

### BRIEF DESCRIPTION OF THE DRAWINGS

FIG. 1 is a perspective view of an end portion of a wrench in accordance with the present invention.

FIG. 2 is an exploded perspective view of the end portion of the wrench in accordance with the present invention.

FIG. 3 is a sectional view of the end portion of the wrench in accordance with the present invention.

FIGS. 4 and FIG. 5 are sectional views similar to FIG. 3, illustrating use of the wrench in accordance with the present invention.

### DETAILED DESCRIPTION OF THE PREFERRED EMBODIMENT

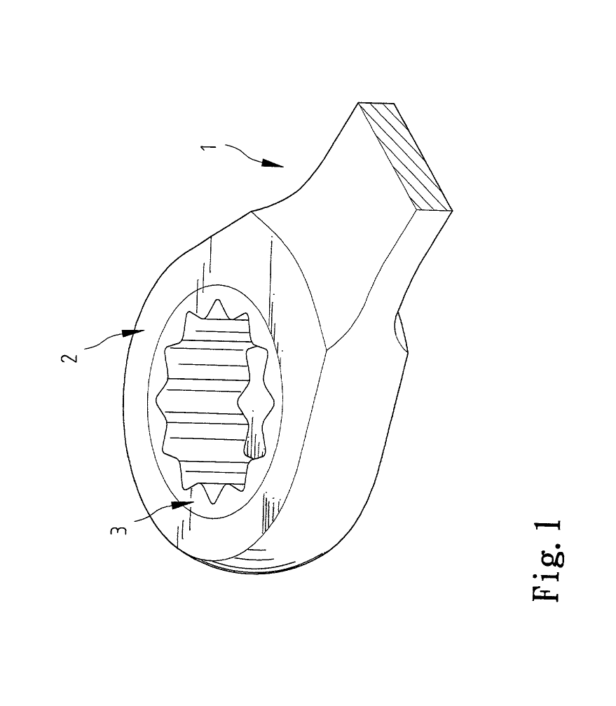

Referring to FIGS. 1 through 3, a wrench in accordance with the present invention is designated by 1 and generally includes a box end 2 having a compartment 21 and a cavity 22 communicated with the compartment 21. Rotatably mounted in the compartment 21 of the box end 2 is a ratchet wheel 3 that includes an inner polygonal periphery 35 for engaging with a fastener (such as a nut, bolt head, etc) and a plurality of teeth 36 on an outer periphery thereof. A first annular ledge 32 and a second annular ledge 34 are formed on a first end and a second end of the outer periphery of the ratchet wheel 3, respectively. Namely, the ledges 32 and 34 are axially spaced from each other. In addition, an annular groove 34 is defined in the outer periphery of the ratchet wheel 3 for receiving a C-clip 24 to thereby rotatably mount the ratchet wheel 3 in the compartment 21 of the box end 2.

A pawl 4 is mounted in the cavity 22 of the box end 2 and a portion of an elastic element (e.g., a spring 42) is mounted around a stem 42 of the pawl 4 to bias the pawl 4 toward the ratchet wheel and thus engage with the teeth 36 of the ratchet wheel 3.

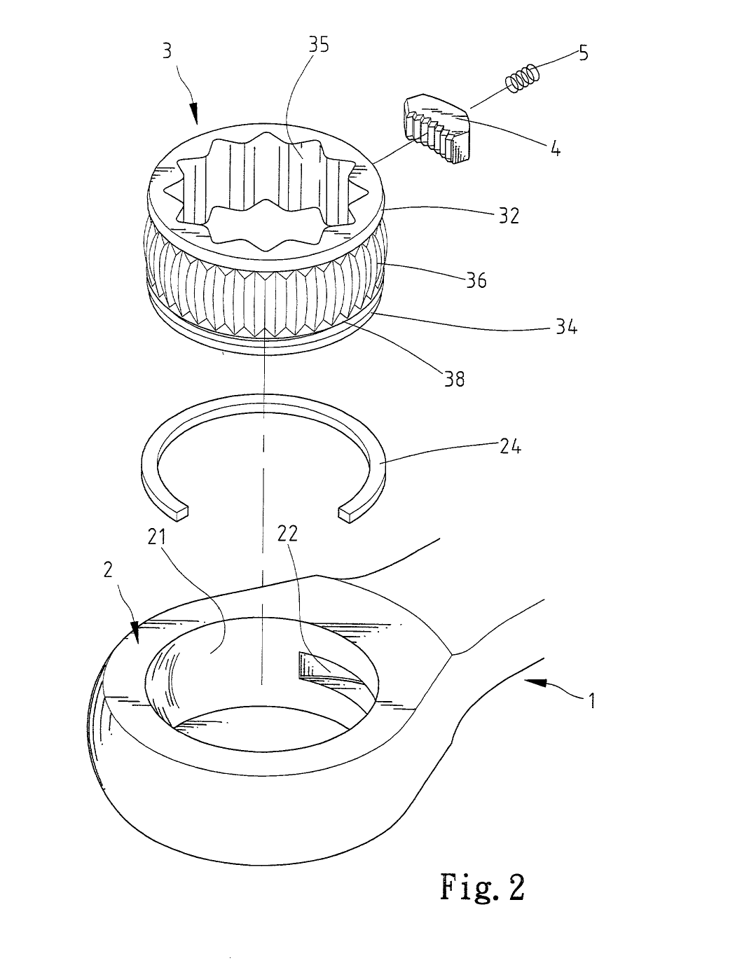

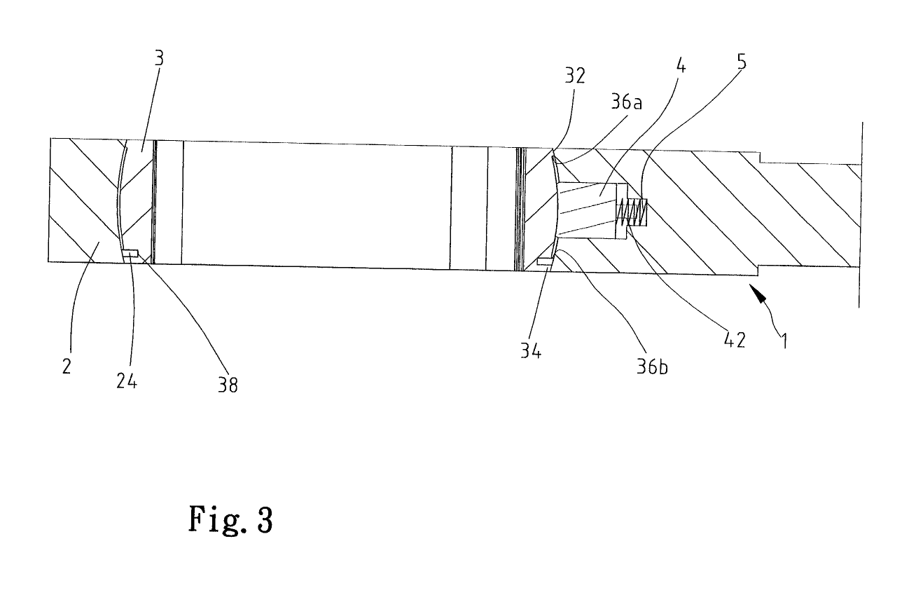

As illustrated in FIGS. 2 and 3, the annular ledge 32 defines a retaining edge 36a for the pawl 4 and the C-clip 34 defines another retaining edge 36b for the pawl 4, which will be described later. Alternatively, the retaining edge 36b may be formed by the annular ledge 34.

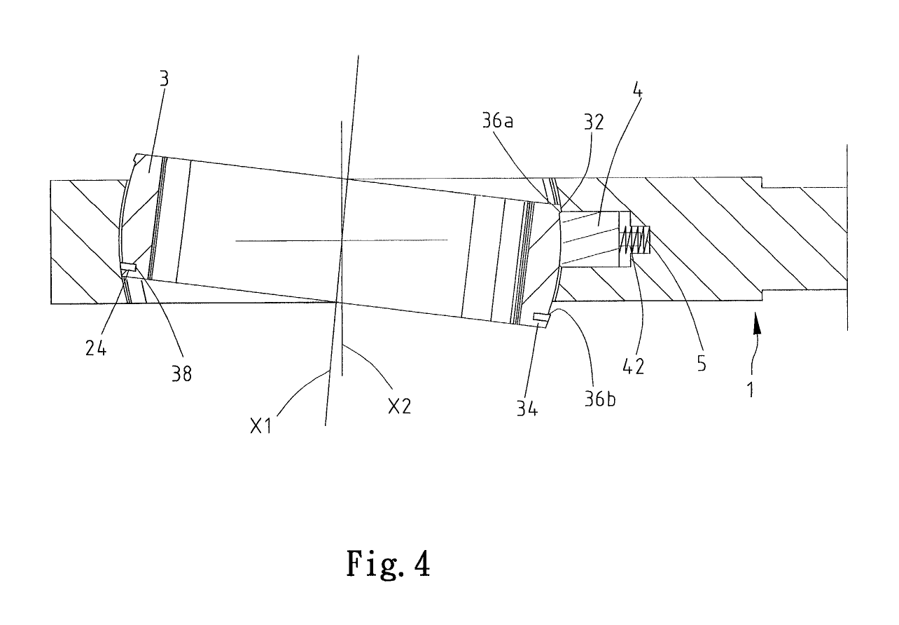

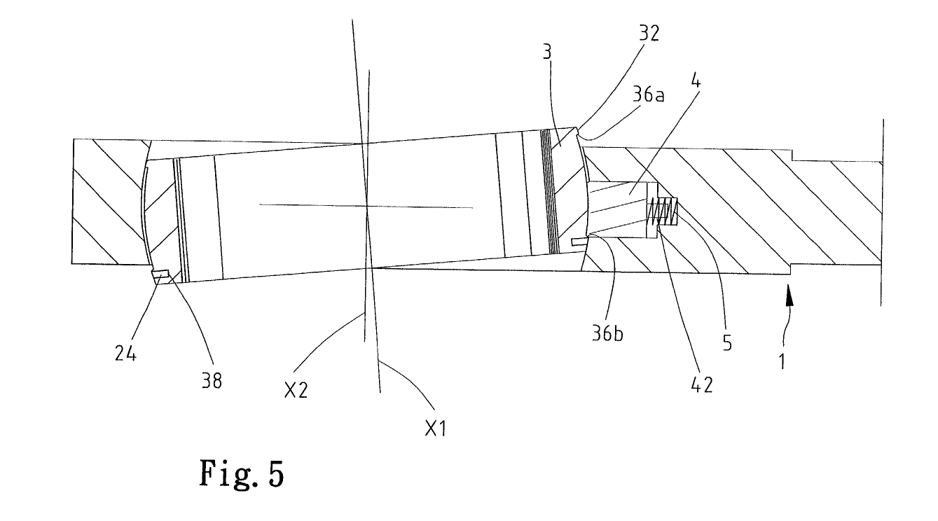

As illustrated in FIGS. 4 and 5, the ratchet wheel 3 is in universal joint with an inner periphery of the box end 2 that defines the compartment 21 so that the ratchet wheel 3 may be turned to a desired orientation in response to location of the fastener (not shown) to be loosened or tightened. In addition, disengagement of the ratchet wheel 3 from the box end 2 is prevented by the retaining edges 36a and 36b that are in contact with the pawl 4 when the ratchet wheel 3 reaches its critical position, best shown in FIGS. 4 and 5. Namely, the retaining edges 36a and 36b restrain a tilt angle of a central axis X1 of the ratchet wheel 3 relative to a central axis X2 of the compartment 21 of the box end 2. When the ratchet wheel 3 is in an upright status, the central axis X1 of the ratchet wheel 3 coincides with the central axis X2 of the compartment 21, as shown in FIG. 3.

The pawl 4 is biased by the spring 42 to engage with the ratchet wheel 3 to thereby allow ratcheting operation of the wrench in a predetermined direction and free rotation of the ratchet wheel 3 in a reverse direction. It is noted that the wrench 1 may include means for switching position of the pawl 4 to change the ratcheting direction of the wrench.

Although the invention has been explained in relation to its preferred embodiment, it is to be understood that many other possible modifications and variations can be made without departing from the scope of the invention as hereinafter claimed.

What is claimed is:

1. A wrench comprising:
a box end comprising a compartment and a cavity;
a ratchet wheel rotatably mounted in the compartment, the ratchet wheel being in universal joint with an inner periphery defining the compartment of the box end, the ratchet wheel including a plurality of teeth on an outer periphery thereof;
a pawl mounted in the cavity for engaging with the ratchet wheel;
means for biasing the pawl toward the ratchet wheel and thus engaging with the teeth of the ratchet wheel.

2. The wrench as claimed in claim 1, further comprising means for restraining a tilt angle of a central axis of the ratchet wheel relative to a central axis of the compartment of the box end.

3. The wrench as claimed in claim 1, wherein the ratchet wheel includes an inner polygonal periphery.

4. The wrench as claimed in claim 1, further comprising means for changing position of the pawl relative to the ratchet wheel, thereby changing ratcheting direction of the wrench.

5. The wrench as claimed in claim 1, wherein the outer periphery of the ratchet wheel includes an annular groove for receiving a C-clip to thereby rotatably mount the ratchet wheel in the compartment of the box end.

6. The wrench as claimed in claim 1, wherein the outer periphery of the ratchet wheel includes an annular ledge formed on an end thereof for engaging with the pawl to prevent disengagement of the ratchet wheel from the compartment of the box end.

7. The wrench as claimed in claim 1, wherein the outer periphery of the ratchet wheel includes a first annular ledge and a second annular ledge that is axially spaced from the first annular ledge, each of the first annular ledge and the second annular ledge being engagable with the pawl to prevent disengagement of the ratchet wheel from the compartment of the box end.
